(19) United States
(12) Patent Application Publication
(10) Pub. No.: US 2006/0254143 A1
(43) Pub. Date: Nov. 16, 2006

(54) Tilt-latch assembly for a sash window

(76) Inventors: Dean Pettit, St. John, IN (US); Vincent F. Eslick, Chicago, IL (US)

Correspondence Address: WALLENSTEIN & WAGNER, LTD., 311 SOUTH WACKER DRIVE, 53RD FLOOR, CHICAGO, IL, 60606, US

(21) Appl. No.: 11/376,723

(22) Filed: Mar. 15, 2006

Related U.S. Application Data
(63) Continuation-in-part of application No. 11/296,854, filed on Dec. 7, 2005.
(60) Provisional application No. 60/662,085, filed on Mar. 15, 2005.

(51) Int. Cl. E05D 15/22

(52) U.S. Cl. 49/185

(57) ABSTRACT

A tilt-latch assembly (10) is used in a window assembly (11). The window assembly (11) has a sash window (12) slidable within a master frame (14) between a pair of guide rails (16), each guide rail (16) forming a shoe channel (17) having a channel base (18). The assembly includes a tilt-latch (40) having a housing (42) supported by the sash window (12) and having an outward end opening (53). The tilt-latch (40) also includes a latch bolt (46) having a distal end (60). The latch bolt (46) is slidably retained by the housing (42). The distal end (60) of the latch bolt (46) has an aperture (62). The assembly (10) also includes a balance assembly (15) including a spool holder (30). The spool holder (30) is fastened to the channel base (18) and has a projection (41) thereon. When the sash window (12) is in a closed position, the aperture (62) of the latch bolt (46) receives the projection (41) of the spool holder (30).

### RELATED APPLICATIONS

The present application claims priority to and the benefit of U.S. Provisional Application No. 60/662,085, filed on Mar. 15, 2005, and this application is further a continuation-in-part application of co-pending U.S. patent application Ser. No. 11/296,854, filed on Dec. 7, 2005, which applications are incorporated by reference and made a part hereof.

### TECHNICAL FIELD

The invention relates to window hardware for windows slidable within a master frame, more specifically, it is related to a tilt-latch assembly for a sash window.

### BACKGROUND OF THE INVENTION

A pivotal sash window adapted for installation in a master frame of a sash window assembly is well known. The sash window is slidable within the master frame. Typically, tilt-latches are installed on or in the sash window and, along with other cooperating hardware, allow the sash window to be pivoted from the frame. One example of such a tilt-latch is shown in U.S. Pat. No. 6,155,615. In some sash window assemblies, excessive wind loads can cause certain tilt-latches to become disengaged from the master frame allowing unwanted pivoting and disengagement of the sash window from the master frame. This can result in damage to the window assembly and injury. While tilt-latches according to the prior art provide a number of advantageous features, they nevertheless have certain limitations.

The present invention is provided to solve the problems discussed above and other problems, and to provide advantages and aspects not provided by prior tilt-latches of this type. A full discussion of the features and advantages of the present invention is deferred to the following detailed description, which proceeds with reference to the accompanying drawings.

### SUMMARY OF THE INVENTION

A tilt-latch assembly is provided for a sash window assembly. The tilt-latch assembly has cooperative structure that resists loads on the sash window assembly to minimize or prevent unwanted sash window disengagement from the master frame.

A tilt-latch assembly is provided for use with a window assembly having a sash window slidable within a master frame between a pair of guide rails, each guide rail forming a shoe channel having a channel base. The assembly includes a tilt-latch having a housing adapted to be supported by the sash window and having an outward end opening. The tilt-latch also includes a latch bolt slidably retained within the housing and having a distal end slidable between an extended position and a retracted position. The assembly also includes a spool holder that supports a coil spring of a balance system for the window assembly. The spool holder is preferably fastened to the channel base. The spool holder and the distal end of the latch bolt each have cooperative structure thereon, and the cooperative structure of the spool holder and the cooperative structure of the latch bolt cooperatively engage each other when the latch bolt is in the extended position and the sash window is in the closed position. The tilt-latch assembly provides increased resistances to wind loads experienced by the sash window assembly.

According to one aspect of the invention, the cooperative structure of the spool holder is a projection and the cooperative structure of the latch bolt is an aperture. In a closed window position, the aperture of the latch bolt receives the projection.

According to another aspect of the invention, the projection is a flat tongue and the aperture is a notch in the latch bolt. The tongue is received in the notch when the sash window is in a closed position.

According to another aspect of the invention, the projection is a round peg and the aperture extends completely through the latch bolt.

The present invention also provides a spool holder for use with a window assembly having a sash window slidable within a master frame, as described above. The spool holder includes a body adapted to be fastened to the shoe channel, a spool held within the body and having an end adapted to be connected to a brake shoe positioned within the shoe channel, and a retainer attached to the body. The retainer is adapted to engage the latch bolt when the sash window is in the closed position.

According to one aspect of the invention, the retainer is a projection extending from a top surface of the body and adapted to be received in an aperture in the latch bolt when the sash window is in the closed position.

The present invention further provides a tilt-latch assembly for use with a window assembly having a sash window slidable within a master frame as described above, including a latch bolt adapted to be supported by the top rail of the sash window and a balance assembly adapted to be mounted in the shoe channel and adapted to have a portion attached to the sash window to provide a biasing force to the sash window. The balance assembly has a retainer thereon, and the retainer engages the latch bolt when the sash window is in the closed position.

According to one aspect of the invention, the balance assembly includes a brake shoe adapted to be slidably positioned within the channel and attached to the sash window, a spool holder, and a coil spring held by the spool holder and having an end attached to the brake shoe. The spool holder supports the retainer.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a perspective view of a window assembly including a tilt-latch assembly of the present invention;

FIG. 2 is a front view of a mounted spool holder having a retainer of the present invention;

FIG. 3 is a perspective view of the spool holder;

FIG. 4 is a rear view of the spool holder of FIG. 3;

FIG. 5 is a side view of the spool holder of FIG. 3;

FIG. 6 is a top view of the spool holder of FIG. 3;

FIG. 7 is a top view of a tilt latch housing of the present invention;

FIG. 8 is a bottom view of the tilt latch housing of FIG. 7;

FIG. 9 is a perspective view of a latch bolt of the present invention that is slidably supported in the tilt-latch housing of FIGS. 7-8;

FIG. 10 is a partial schematic top view of the tilt-latch assembly of the present invention installed in the window assembly of FIG. 1, with the sash window being in a closed position within the master frame;

FIG. 11 is a side view of the tilt-latch assembly of FIG. 10;

FIG. 12 is a partial exploded perspective view of another embodiment of a tilt-latch assembly of the present invention;

FIG. 13 is a partial schematic side view of the tilt-latch assembly of FIG. 12 installed in the window assembly of FIG. 1, with the sash window being in a closed position within the master frame; and,

FIG. 14 is a partial schematic front view of the tilt-latch assembly shown in FIG. 13.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

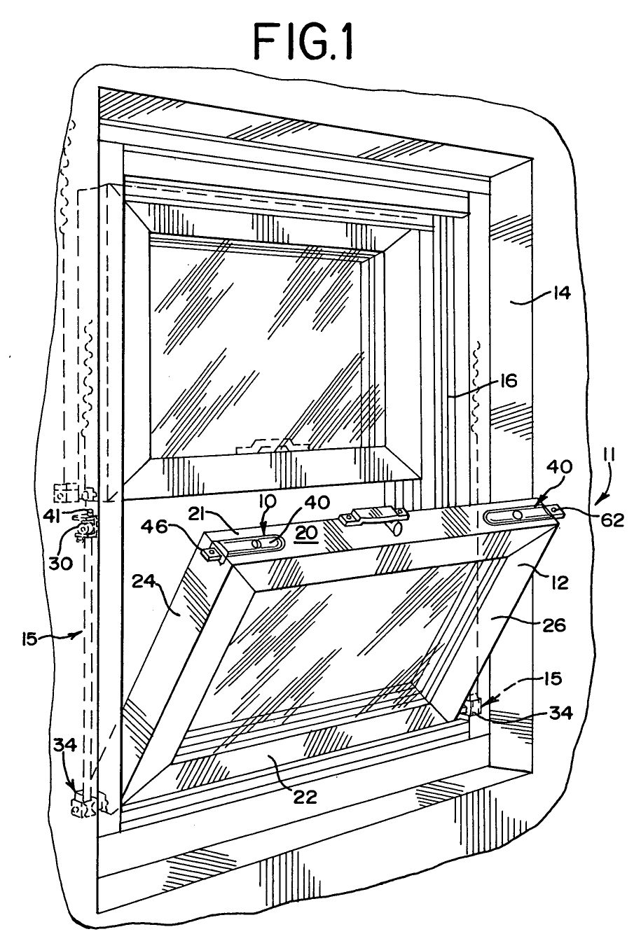

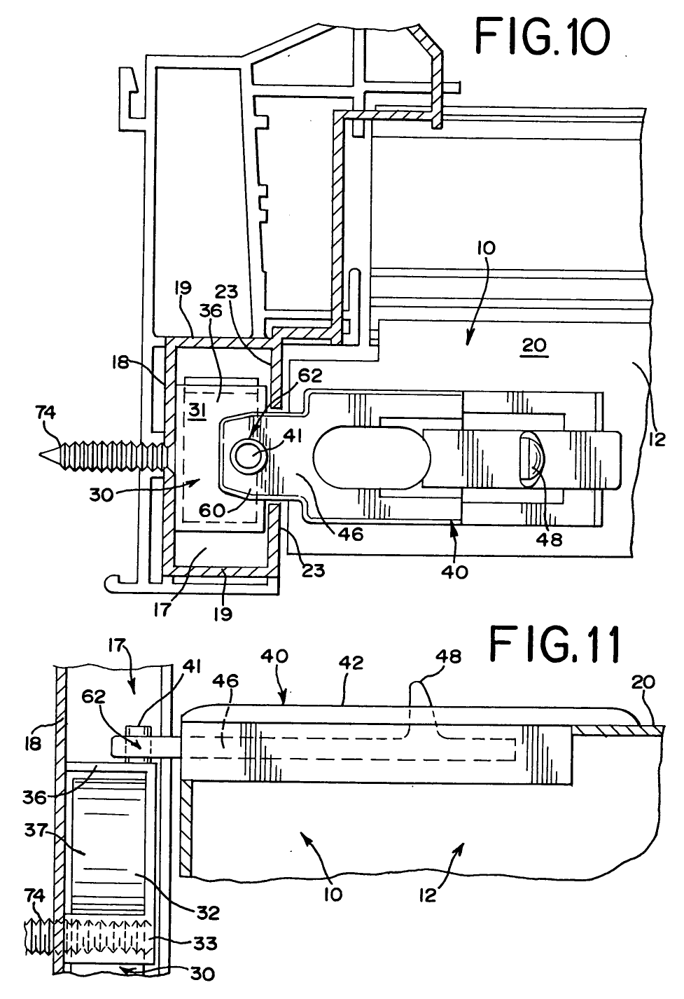

FIG. 1 shows a tilt-latch assembly of the present invention, generally designated with the reference numeral 10, used in a sash window assembly 11. The sash window assembly 11 shown in FIG. 1 is a double-hung window assembly having a pivotal sash window 12 installed in a master frame 14. The particular sash window assembly 11 shown in FIG. 1 is made from extruded vinyl although it could also be made from other materials including wood. The tilt-latch assembly 10 could also be used in all types of pivotal windows or structures. The sash window 12 is pivotally mounted to the master frame 14 by a brake shoe assembly 34. As is well known, the master frame 14 has opposed, vertically extending guide rails 16 that form a shoe channel 17. As shown in FIG. 10, the shoe channel 17 includes a channel base 18, a pair of channel sidewalls 19 extending from the base 18, and a pair of shoulders 23 extending inward from the sidewalls 19. It is understood that the base 18 can be defined on the other wall structures of the shoe channel 17. A balance assembly 15 is also included an may incorporate the brake shoe 34. The balance assembly 15 has one portion connected to the master frame 14 and another portion connected to the sash window 12, preferably through the brake shoe 34. As further shown in FIG. 1, the sash window 12 has a top sash rail 20 having a top surface 21, a base 22 and a pair of stiles 24, 26, cooperatively connected together at adjacent extremities thereof to form a sash frame, typically rectangular although other shapes are possible. The tilt-latch portion of the tilt-latch assembly 10 is typically mounted to the top surface 21 of the top sash rail 20.

As shown in FIGS. 1, 2, 10, 11, and 13, the balance assembly 15 is preferably mounted in the shoe channel 17 and attached to the sash window 12 to provide a biasing force to the sash window, facilitating opening of the sash window 12. The balance assembly 15 generally includes a spool holder 30, a spool or spring assembly 32, and a brake shoe or pivot brake assembly 34. The spool holder 30 generally includes a body 36 attached to the shoe channel 17, having a top surface 31, a spool support 38, and a fastener hole 33 for mounting to the shoe channel 17. The spool support 38 is preferably a rounded or curved surface. A projection 41 preferably extends from the top surface 31 of the spool holder 30, as described below. As seen in FIGS. 10 and 11, the spool holder 30 is preferably attached in the shoe channel 17. In one preferred embodiment, the spool holder is mounted on the channel base 18. Specifically, the base 32 of the spool holder 30 abuts against the channel base 18 and a screw or other fastener 74 is inserted through the fastener hole 33 to attach the spool holder 30 to the channel base 18. As generally seen in FIGS. 10 and 11, the spool holder 30 is oriented within the shoe channel 17 such that the projection 41 points in a generally upward vertical direction. Also, the spool holder 30 is located near a mid-point of a height of the guide rails 16, but in an appropriate position to cooperate with the tilt-latch 40 as described below.

The spool 32 is preferably a metal coil spring 32 having a coiled portion 37 and a free end 39. The coiled portion 37 is supported by the spool support 38. The free end 39 of the coil spring 32 is connected to the brake shoe 34 to exert an upward bias on the brake shoe 34. The brake shoes 34 are preferably slidably mounted within the shoe channel 17, and the sash window 12 is pivotably connected to the brake shoes 34, thus slidably mounting the sash window between the guide rails 16. The preferred brake shoe 34 expands to exert a braking force on the shoe channel 17 when the sash window 12 is pivoted outward in order to prevent the pivoted window from sliding. The balance assembly 15 may also take the form of a block and tackle assembly (not shown) or other type of balancing assembly.

As shown in FIGS. 1 and 11, the tilt-latch assembly 10 generally comprises a tilt-latch 40 and a balance assembly 15 having a retainer 41. As previously discussed, the tilt-latch 40 is mounted in the top sash rail 20 of the sash window 12. As will be discussed in greater detail below, the tilt-latch 40 and the retainer 41 have cooperative structure to enhance the overall operation of the sash window assembly 11. As also discussed in greater detail below, in a preferred embodiment, the retainer 41 is incorporated into the spool holder 30.

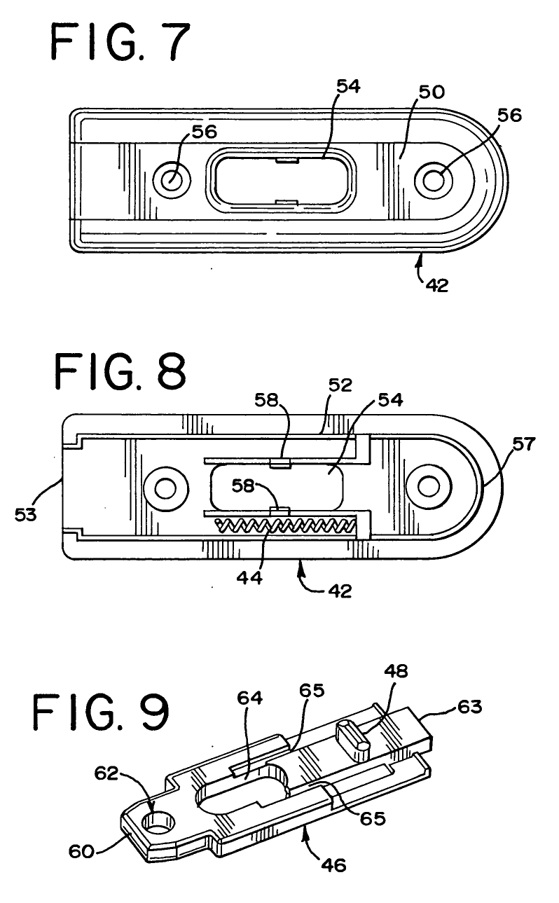

As shown in FIGS. 7-11, the tilt-latch 40 comprises a housing 42, a biasing spring 44 (shown schematically in FIG. 8), a latch bolt 46, and an actuator 48. The housing 42 is adapted to be supported by the top rail 20. The latch bolt 46 is disposed within the housing 42. The actuator 48 is connected to the latch bolt 46 and is designed to allow a user to retract the latch bolt 46 into the housing 42 against the biasing force of the spring 44. As shown, the actuator 48 is shown integrally formed with the latch bolt 46. However, it is understood that the actuator 48 may be a separate component of the tilt-latch 40 and attached to the latch bolt 46 by any of various means.

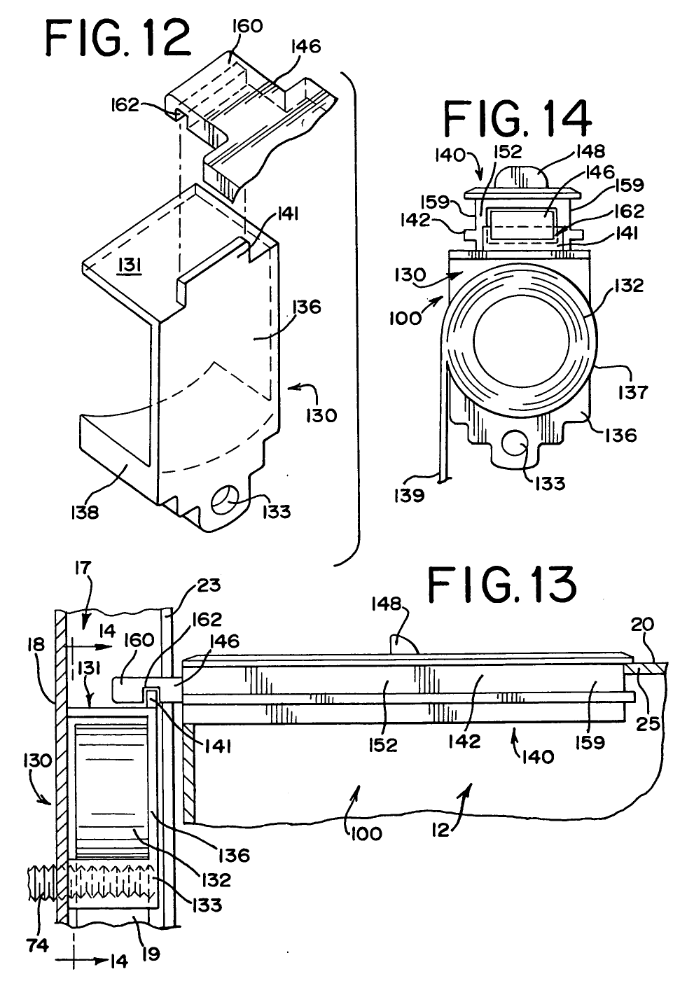

As shown in FIGS. 7 and 8, the preferred housing 42 is of a top mount construction, although other configurations are possible, and includes a top wall 50 and two depending side walls 52 that define an outward end opening 53. The side walls 52 generally curve and meet to define a closed end 57. The top wall 50 includes a slot 54 and a pair of screw holes 56. The housing 42 further has a pair of opposed latch slides 58. As shown in FIGS. 13-14, one embodiment of the tilt latch 140 has a housing 142 substantially similar in structure to the housing shown in U.S. Pat. No. 5,139,291, which is incorporated herein by reference. The housing 142 shown in FIGS. 13-14 has a groove 159 in each side wall 152 that accepts a header rail 25 of the top sash rail 20 to secure the tilt latch 140 within the top sash rail 20.

As shown in FIGS. 9-11, the latch bolt 46 is adapted to be slidably retained by the housing 42. The latch bolt 46 has an extended position (FIGS. 10-11) and a retracted position. The latch bolt 46 generally has cooperative structure 62 thereon, which cooperatively engages with cooperative structure 41 on the spool holder 30 when the sash window 12 is in the closed position and the latch bolt 46 is in the extended position. The latch bolt 46 shown in FIGS. 9-11 includes a distal end 60 having an aperture 62 and a proximal end 63 opposed from the distal end 60. The distal end 60 is relatively far from the closed end 57 of the housing 42, and the proximal end is relatively close to the closed end 57 of the housing 42. The distal end 60 is preferably tapered. The aperture 62 extends vertically through the latch bolt 46. While in one preferred embodiment the aperture 62 extends completely through the latch bolt 46, the aperture 62 could extend through a portion of the latch bolt 46. For example, the distal end 60 could be hollowed-out on one side of the latch bolt 46. The aperture 62 shown in FIG. 9 is generally circular and in another preferred embodiment, the aperture 62 is oblong or rectangular. It is understood that other shapes can be used including square, oval, etc. Located between the distal end 60 and the proximal end 63 are the actuator 48 and a screw slot 64. The screw slot is generally elongated to allow sliding of the latch bolt 46 around a screw (not shown) or other fastener used to fasten the tilt-latch on the top rail 20.

As further shown in FIG. 9, the latch bolt 46 includes a pair of latch slots 65. The latch slots 65 receive the latch slides 58 of the housing 42. The latch bolt 46 and housing 42 cooperate to allow relative sliding movement between the latch bolt 46 and housing 42. It is understood that several structures can be employed to slidably support the latch bolt 46 within the housing 42. The latch bolt 46 and housing 42 are preferably symmetric along their respective central axes.

To assemble the tilt-latch 40, the latch bolt 46 is inserted into the housing 42 such that the distal end 60 extends through the outward end opening 53, the screw slot 64 aligns with one of the screw holes 56 of the top wall 50, and the actuator 48 extends through the top wall slot 54 of the housing 42. The latch slides 58 snappingly and slidingly engage the latch bolt 46. The latch bolt 46 is then slidable between an extended position wherein the distal end 60 extends through the outward end opening 53 and a retracted position wherein the distal end 60 retracts towards the housing 42, such as for pivoting the sash window. Also, the spring 44 or other resilient member is preferably positioned between the proximal end 63 of the latch bolt 46 and the housing 42 to bias the latch bolt 46 towards its extended position.

The assembled tilt latch 40 is attached to the top surface 21 of the top sash rail 20, such as by use of screws or other fasteners inserted through the screw holes 56 of the top wall 50 of the housing 42. Before doing so, the tilt latch 40 is positioned as generally shown in FIG. 1. It is further understood that other mounting structures could be incorporated on the housing 42. For example, flush-mount structure could be employed wherein the structure would cooperate with the top rail structure eliminating the need for separate screw fasteners through screw holes 56, such as in U.S. Pat. No. 5,139,291. As described above, the housing 142 shown in FIGS. 13-14 has a groove 159 in each side wall 152 that accepts a header rail 25 of the top sash rail 20 to secure the tilt latch 140 within the top sash rail 20.

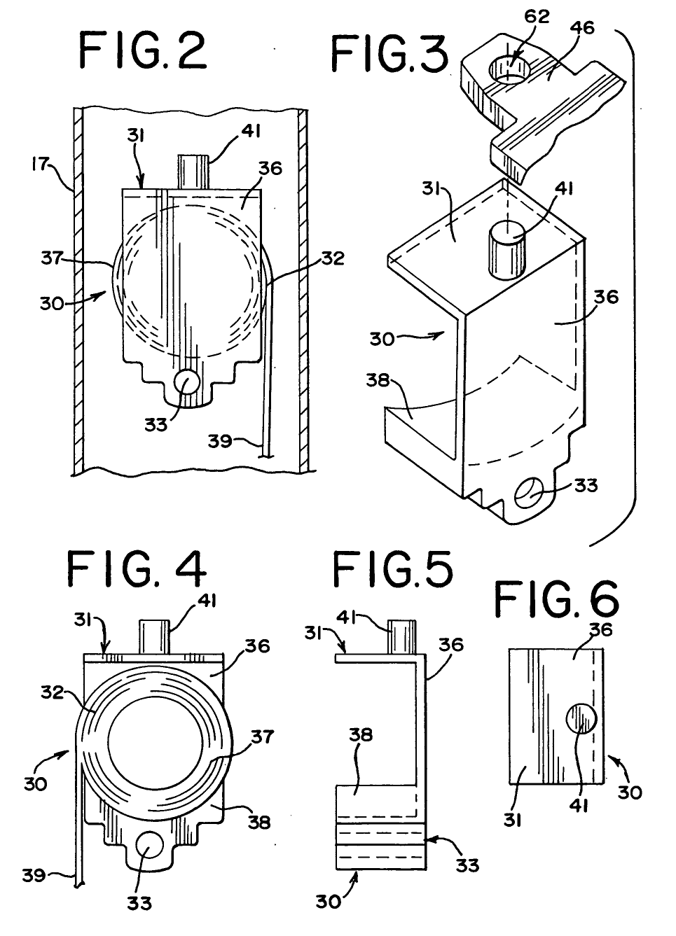

Generally, the balance assembly 15 has a retainer 41 thereon that engages the latch bolt 46 when the sash window 12 is closed. In a preferred embodiment of the tilt latch assembly 10, illustrated in FIGS. 1-11, the retainer 41 takes the form of a projection 41 on the top side 31 of the spool holder 30. As shown in FIGS. 2-6, the projection 41 is a cylindrical peg 41. Likewise, the latch bolt 46 contains a cooperative structure 62 for cooperatively engaging the retainer 41. Preferably, this cooperative structure is an aperture 62 located in the distal end 60 of the latch bolt 46 that receives the projection 41 on the spool holder 30, as shown in FIGS. 10-11. In the preferred embodiment, the aperture 62 is round and extends completely through the latch bolt 46 vertically. However, in other embodiments, the aperture 62 may not extend completely through the latch bolt 46, or may extend completely through the latch bolt 46 horizontally. As described herein, the retainer 41 will resist any lateral movement of the latch bolt 46, providing resistance to wind loads. It is understood that the retainer 41 can take many different forms, including projections 41 of many different shapes, and the cylindrical peg 41 is but one preferred configuration. In still further embodiments, the projection 41 and the aperture 62 are differently shaped. For example, the projection 41 and aperture 62 may engage each other in a horizontal arrangement, rather than a vertical arrangement as shown in the FIGS.

In the embodiment of the tilt-latch assembly 100 illustrated in FIGS. 12-14, the projection 141 is a wide, flat tongue 141 extending upward from the top side 131 of the spool holder 130. As in the previous embodiments, the latch bolt 146 has a cooperative structure 162 for cooperatively engaging the retainer 141. Preferably, this cooperative structure is a slot or notch 162 located in the distal end 160 of the latch bolt 146 that receives the projection 170 on the spool holder 130, as shown in FIGS. 13-14. In the embodiment shown, the notch 162 extends completely through the latch bolt 146 horizontally, however, in other embodiments, the notch 162 may extend completely through the latch bolt 146 vertically, or may not extend completely through the latch bolt 146. In still further embodiments, the projection 141 and the notch 162 are differently shaped. Additionally, as described above, the housing 140 of this embodiment is configured for insertion into the top sash rail 20 without the use of fasteners. Other components of the window assembly 11 and the tilt latch assembly 100 are preferably the same or similar in this embodiment as in the embodiments previously disclosed. As in the above embodiments, the retainer 141 of this embodiment will resist any lateral movement of the latch bolt 146, providing resistance to wind loads.

In still other embodiments, the retainer 41 may be a separate piece affixed to the spool holder 30, or otherwise connected to the balance assembly 15, and may take one of a number of different shapes or forms. For example, the retainer 41 may be a hook (not shown) attached to the spool holder 30.

More generally, the tilt-latch 40 and spool holder 30 have cooperative structure 41,62 that cooperatively engage each other when the sash window 12 is in the closed position and the latch bolt 46 is in the extended position. The cooperative structures 41,62 provide resistance from unwanted disengagement of the sash window 12 from the master frame 14, in addition to an outer surface of the distal end of the latch bolt 46 engaging the guide rails 16 to maintain the sash window 12 in an un-pivoted configuration. The present invention contemplates the use of any structural combination of cooperative structure 41,62 that effectively cooperatively engage each other. The cooperative structure 41,141,62,162 of the spool holder 30,130 and latch bolt 46,146 of the above embodiments are described by way of example as a projection 41,141 cooperatively engaging an aperture 62 or a notch 162. More generally, the cooperative structure 41,62 preferably includes one structure having a projection and one structure having a receiver. It is understood that either structure could include the projection and the receiver. For example, the latch bolt 46 could include a projection and the spool holder 30 could include a receiver in the form of an aperture to receive the protrusion. In another embodiment, the cooperative structure 41,62 could include interlocking hooks or other non-male/female connections. In one preferred embodiment, however, the latch bolt 46 has the receiver 62 and the spool holder has the projection 41. In addition, the receiver may be formed by a circumferential structure that defines an opening, such as the receiver being formed by latch bolt structure forming the aperture 62. Regardless of the particular configuration employed, the cooperative structures 41,62 cooperatively engage each other to prevent lateral movement of the latch bolt 46 and hold the window closed more securely.

Still further, it is understood that the spool holder 30 is preferably mounted in the shoe channel 17 so it can cooperate with the tilt-latch 40. The spool holder 30 could be mounted in various ways included being incorporated into other balance assembly structure. The spool holder 30 can be mounted on other walls of the shoe channel, but in a preferred embodiment, the spool holder 30 is mounted on the channel base 18. The spool holder 30 could also be arranged such that the projection 41 is received by the aperture 62 from a top side of the latch bolt 46.

In use, the sash window 12 is slidable within the master frame 14 between a closed position wherein the sash window 12 is fully lowered and an open position wherein the sash 12 is raised from the closed position. Also, it is understood that the sash window 12 can be pivoted from the master frame 14. (FIG. 1) As the sash window 12 slides within the master frame 14, the distal end 60 of the latch bolt 46 extends into the shoe channel 17. When the sash window 12 is moved from an open position to its closed position, the aperture 62 of the distal end 60 receives the projection 41 on the spool holder 30. That is, a portion of the projection 41 extends through the aperture 62, although there need not necessarily be any contact between the projection 41 and the latch bolt 46. As shown in FIGS. 10-11, in one preferred embodiment, the aperture 62 is larger than the projection 41 so that a space is maintained between a surface of the projection 41 and a surface of the latch bolt 46 defining the aperture 62. It is further shown that when the sash window 12 is in the closed position, a top portion of the projection 41 extends past an upper surface of the latch bolt 46. Therefore, when the sash 12 is in its closed position, the distal end 60 of the latch bolt 46 and the projection 41 are in an interference relationship with one another. More specifically, the projection 41 will resist any lateral movement of the latch bolt 46 that may result from excessive wind conditions or from any object that may forcefully strike the window sash 12. This resists or prevents unwanted pivoting or disengagement of the sash window from the master frame 14. It is understood that the same configuration is achieved by the tilt-latch assembly in FIGS. 12-14, where the tongue 141 is received in the notch 162 when the sash window 12 is in the closed position (FIG. 13).

It should be noted that in other respects the tilt-latch assembly 10 functions in a similar manner as many of the known tilt-latches. That is, when the sash 12 slides within the master frame 14, the distal end 60 of the latch bolt 46 extends into the guide rail 16 to maintain the sash 12 within the master frame 14, in a vertical, un-pivoted configuration. To tilt the sash 12 out of the master frame 14, the latch bolt 46 is moved to its retracted position by use of the actuator 48 thereby removing the distal end 60 from the guide rail 16, to allow the sash 12 to tilt. It is understood that the sash window 12 will be raised slightly such that the latch bolt 46 clears the projection 41. Thus, the aperture 62 no longer receives the projection 41. While being raised, the sash window 12 may still be considered to be in the closed position. The vertical length of the projection could vary, thus varying the amount that the sash window 12 must be raised for the latch bolt 46 to clear the projection 41. Of course, there is a tilt-latch assembly 10 located at each upper corner of the sash window 12, both of which would need to be so manipulated to permit tilting.

The tilt-latch assembly 10,100 provides many benefits. Sash window assemblies are subject to forces when under high wind loads such as from severe thunderstorms, tropical storms, and hurricanes. The cooperative positional relationship between the latch bolt aperture 62 and the projection 41 provides resistance to such wind loads. It is understood that the dimensions of the aperture and projection could be modified as desired to provide full surface-to-surface contact or to vary the clearances between the projection 41 and an interior surface of the latch bolt as defined by the aperture 62. By incorporating the cooperative structure with spool holder 30, additional components are not necessary for the sash window assembly 11.

While the specific embodiments have been illustrated and described, numerous modifications come to mind without significantly departing from the spirit of the invention, and the scope of protection is only limited by the scope of the accompanying claims.

What is claimed is:

1. A tilt-latch assembly for use with a window assembly having a sash window slidable within a master frame between a pair of guide rails, each guide rail forming a shoe channel, the sash window having an open position and a closed position, the tilt-latch assembly comprising:
a tilt-latch adapted to be supported by the sash window, the tilt-latch having a latch bolt slidable between an extended position and a retracted position; and
a spool holder adapted to be positioned within the shoe channel,
wherein the spool holder and the latch bolt each have cooperative structure thereon, and wherein the cooperative structure of the spool holder and the cooperative structure of the latch bolt cooperatively engage each other when the latch bolt is in the extended position and the sash window is in the closed position.

2. The tilt-latch assembly of claim 1, wherein the cooperative structure of the spool holder comprises a projection and the cooperative structure of the latch bolt comprises an aperture, wherein the projection is received in the aperture when the latch bolt is in the extended position and the sash window is in the closed position.

3. The tilt-latch assembly of claim 2, wherein the projection is a cylindrical peg and the aperture extends completely through the latch bolt.

4. The tilt-latch assembly of claim 2, wherein the aperture extends vertically through the latch bolt.

5. The tilt-latch assembly of claim 1, wherein the cooperative structure of the spool holder comprises a flat tongue and the cooperative structure of the latch bolt comprises a notch, wherein the tongue is received in the notch when the latch bolt is in the extended position and the sash window is in the closed position.

6. The tilt-latch assembly of claim 1, further comprising a coil spring held by the spool holder and having an end adapted to be connected to a brake shoe positioned in one of the shoe channels.

7. The tilt-latch assembly of claim 1, wherein the tilt latch further comprises a housing adapted to be supported by a top rail of the sash window, the latch bolt slidably disposed within the housing.

8. A tilt-latch assembly for use with a window assembly having a sash window slidable within a master frame between a pair of guide rails, each guide rail forming a shoe channel, the sash window mounted on a pair of brake shoes, each brake shoe slidably mounted within each shoe channel, the sash window having an open position and a closed position, the tilt-latch assembly comprising:
a tilt-latch adapted to be supported by the sash window, the tilt-latch having a latch bolt slidable between an extended position and a retracted position, the latch bolt having a distal end having an aperture; and,
a spool holder adapted to be positioned within the shoe channel, the spool holder having a projection thereon,
wherein the aperture receives the projection when the latch bolt is in the extended position and the sash window is in the closed position.

9. The tilt-latch assembly of claim 8, further comprising a coil spring held by the spool holder and having an end adapted to be connected to the brake shoe.

10. The tilt-latch assembly of claim 8, wherein the projection is a round peg and the aperture extends completely through the latch bolt.

11. The tilt-latch assembly of claim 8, wherein the projection comprises a flat tongue and the aperture comprises a notch in the latch bolt, the tongue received in the notch when the latch bolt is in the extended position and the sash window is in the closed position.

12. The tilt-latch assembly of claim 8, wherein the aperture is larger than the projection, wherein a space is maintained between a surface of the projection and a surface of the latch bolt defining the aperture when the aperture receives the projection.

13. The tilt-latch assembly of claim 8, wherein when the aperture receives the projection, a top portion of the projection extends past an upper surface of the latch bolt.

14. The tilt-latch assembly of claim 8, wherein the aperture is generally oblong.

15. A spool holder for use with a window assembly having a sash window slidable within a master frame between a pair of guide rails, each guide rail forming a shoe channel, the sash window mounted on a brake shoe, the brake shoe slidably mounted within the shoe channel, the window assembly having a balance assembly having a coil spring having a coiled portion and a free end connected to the brake shoe, the sash window having an open position and a closed position, the window assembly further having a tilt-latch supported by the sash window, the tilt-latch having a latch bolt moveable between retracted and extended positions, the spool holder comprising:
a body adapted to be fastened to the shoe channel, the body adapted to hold the coiled portion of the coil spring; and
a retainer attached to the body, the retainer adapted to engage the latch bolt when the sash window is in the closed position and the latch bolt is in the extended position.

16. The spool holder of claim 15, wherein the body has a curved surface adapted to support the coiled portion.

17. The spool holder of claim 15, wherein the retainer comprises a projection extending from a top surface of the body and adapted to be received in an aperture in the latch bolt when the sash window is in the closed position and the latch bolt is in the extended position.

18. The spool holder of claim 15, further comprising a fastener extending through a fastener hole in the body and adapted to fasten the body to the shoe channel.

19. A tilt-latch assembly for use with a window assembly having a sash window slidable within a master frame between a pair of guide rails, each guide rail forming a shoe channel, the sash window mounted on a pair of brake shoes, each brake shoe slidably mounted within each shoe channel, the sash window having an open position and a closed position, the tilt-latch assembly comprising:
a tilt-latch adapted to be supported by the sash window, the tilt-latch having a latch bolt with a distal end, the latch bolt slidable between an extended position and a retracted position; and
a spool holder adapted to be fastened within the shoe channel and adapted for holding a coil spring having a free end adapted to be connected to the brake shoe,
wherein the spool holder and the distal end of the latch bolt each have cooperative structure thereon, and wherein the cooperative structure of the spool holder and the cooperative structure of the latch bolt cooperatively engage each other when the latch bolt is in the extended position and the sash window is in the closed position.

20. The tilt-latch assembly of claim 19, wherein the cooperative structure of the spool holder comprises a projection and the cooperative structure of the latch bolt comprises an aperture, wherein the projection is received in the aperture when the latch bolt is in the extended position and the sash window is in the closed position.

21. A window assembly comprising:
a master frame having a guide rail forming a channel having a base;
a brake shoe slidably disposed within the channel;
a sash window mounted on the brake shoe and slidable along the guide rail, the sash window having an open position and closed position;
a tilt-latch having a housing connected to the sash window, the tilt-latch having a latch bolt slidably supported by the housing between an extended position and a retracted position, the latch bolt having an aperture at a distal end of the latch bolt;
a spool holder positioned within the channel and having a projection thereon, wherein the projection is received by the aperture when the latch bolt is in the extended position and the sash window is in the closed position; and
a coil spring supported by the spool holder and having an end connected to the brake shoe.

22. A tilt-latch assembly for use with a window assembly having a sash window slidable within a master frame between a pair of guide rails, each guide rail forming a shoe channel, the sash window having an open position and a closed position and comprising a top rail, a base rail, and two stiles connected together at adjacent extremities thereof, the tilt-latch assembly comprising:
a latch bolt adapted to be supported by the top rail of the sash window;
a balance assembly adapted to be mounted in the shoe channel and adapted to have a portion attached to the sash window to provide a biasing force to the sash window, the balance assembly having a retainer, the retainer engaging the latch bolt when the sash window is in a closed position.

23. The tilt-latch assembly of claim 22, wherein the balance assembly comprises a spool holder, the spool holder supporting the retainer.

24. The tilt-latch assembly of claim 22, wherein the balance assembly comprises a brake shoe adapted to be slidably positioned within the channel and attached to the sash window, a spool holder, and a coil spring held by the spool holder and having an end attached to the brake shoe, the spool holder supporting the retainer.

25. The tilt-latch assembly of claim 22, wherein the retainer comprises a projection and the latch bolt comprises an aperture, wherein the projection is received in the aperture when the sash window is in the closed position.
